(19) United States
(12) Patent Application Publication
(10) Pub. No.: US 2024/0102518 A1
(43) Pub. Date: Mar. 28, 2024

(54) LINEAR CLUTCH AND METHOD OF MANUFACTURING

(71) Applicant: Blanking Systems Inc., Grafton, WI (US)

(72) Inventor: Frank Oetlinger, Grafton, WI (US)

(73) Assignee: Blanking Systems Inc., Grafton, WI (US)

(21) Appl. No.: 17/936,364

(22) Filed: Sep. 28, 2022

(51) Int. Cl. F16D 41/061

(52) U.S. Cl. CPC F16D 41/061; F16D 2041/0605

(57) ABSTRACT

A linear clutch includes a main body engaged with a locking assembly. The locking assembly includes a spring and a wedge configured to engage the spring. The wedge includes a first surface and a second surface opposite the first surface, with the second surface including a taper configured to engage a taper on a wall section of the main body. The locking assembly also includes a roller bearing assembly configured to fit within the tapers of the first wedge and the main body. Furthermore, the locking assembly includes a lever configured to engage the wedge and to move between an unlocked position and a locked position.

### BACKGROUND OF THE INVENTION

Embodiments of the present invention relate to linear clutches and, more particularly, to one-way and two-way linear clutches that that include a one-way locking assembly or a two-way locking assembly, respectively.

Various organizations utilize applications with linear movement. This linear movement relates to different types of objects and machines. For example, one application of linear movement is a robot moving along a rail as part of an assembly line or to deliver mail. Another example application is linear movement of a mounting assembly along a rail, with the mounting assembly being locked and unlocked at different locations depending on the exact configuration of the application. However, these examples only scratch the surface of different applications of linear movement.

One more specific example is movement of mounting assemblies on an adjustable blanking frame in blanking or die cutting systems. In such a system, a user may position a blanking tool on the adjustable blanking frame in preparation for cutting cardboard or other materials into a desired shape. This adjustable blanking frame includes a plurality of rails that a user may move to a desired position and lock in place with the mounting assembly. The use of an adjustable blanking frame is generally important, as different blanking tools are typically used on the same blanking frame and vary in size. That is, the different blanking tools have at least a different length or width. Thus, when switching out the current blanking tool for a new blanking tool, a user often has to adjust the arrangement of the rails of the blanking frame to account for the different size of the new blanking tool.

Adjusting the blanking frame can become a time-intensive task. The mounting assemblies on the blanking frame require a tool, such as a wrench, to loosen and retighten the mounting assemblies after adjustment. Thus, every time a user needs to adjust the blanking frame, the user has to obtain the appropriate tool, adjust each applicable rail and mounting assembly, and retighten each mounting assembly. Depending on how the blanking frame is configured, a user may need a great deal of time to adjust the blanking frame just one time. However, even when adjusting the blanking frame from one blanking tool to another does not take a large amount of time, the amount of time will build up over the course of the day when using many different blanking tools.

It would therefore be desirable to provide a device that is able to move linearly along an object, be locked in position, and be readjusted in an easy, convenient, reliable, efficient, and effective manner.

### BRIEF STATEMENT OF THE INVENTION

Embodiments of the present invention are directed to one-way and two-way linear clutches that are switchable between an unlocked state in which the linear clutches have bidirectional movement and a locked state in which the linear clutches have unidirectional movement or no movement, respectively.

In accordance with one aspect of the invention, a linear clutch including a main body having a support panel section with an outer side and an inner side opposite the outer side. The main body also includes a first wall section extending from the inner side of the support panel section. The first wall section includes a groove adjacent to the inner side of the support panel section and a first taper adjacent to and extending away from the groove. Further, the main body includes a second wall section extending from the inner side of the support panel section and spaced apart from the first wall section. Additionally, the main body includes a channel extending through the main body adjacent to the groove of the first wall section and defined by the second wall section and the inner side of the support panel section. The channel is configured to receive an object therethrough such that the linear clutch is movable along the object in a first direction and a second direction. Furthermore, the linear clutch includes a locking assembly configured to engage the groove and the taper of the first wall section. The locking assembly includes a first wedge positioned within the groove of the first wall section. The first wedge includes a first surface adjacent to the channel and a second surface opposite the first surface, the second surface comprising a taper extending into the first wedge from the second surface toward the first surface and positioned adjacent to the first taper of the first wall section to form a first taper pocket. A first bearing assembly of the locking assembly is positioned within the first taper pocket and includes a first roller bearing. In addition, the locking assembly includes a lever secured at the first wall section and engaged with the wedge. The lever is configured to switch the linear clutch between an unlocked state in which the linear clutch is able to move along the object in the first direction and the second direction and a locked state in which the linear clutch cannot move along the object in the first direction. The locking assembly further includes a first spring biasing the first wedge to engage the lever.

In accordance with another aspect of the invention, a method of manufacturing a linear clutch includes providing a main body. The main body includes a support panel section comprising an outer side and an inner side opposite the outer side. In addition, the main body includes a first wall section extending from the inner side of the support panel section and including a groove adjacent to the inner side of the support panel section and a first taper adjacent to and extending away from the groove. The main body further includes a second wall section extending from the inner side of the support panel section and spaced apart from the first wall section. The main body additionally includes a channel extending through the main body adjacent to the groove of the first wall section and defined by the second wall section and the inner side of the support panel. The channel is configured to receive an object therethrough such that the linear clutch is movable along the object in a first direction and a second direction. Furthermore, the method includes installing a locking assembly onto the main body by securing a lever at the first wall section and installing a first bearing assembly comprising a roller bearing in the first taper of the first wall section. Installing the locking assembly also includes providing a first wedge including a first surface and a second surface opposite the first surface and including a taper extending into the first wedge from the second surface toward the first surface. Additionally, installing the locking assembly includes installing the first wedge within the groove of the first wall section with a first spring such that the first taper of the first wall section and the taper of the second surface of the first wedge are adjacent to each other and form a first taper pocket in which the first bearing assembly is positioned; the first spring biases the first wedge to engage the lever; and the lever is able to switch the linear clutch between an unlocked state in which the linear clutch is able to move along the object in the first direction and the second direction and a locked state in which the linear clutch cannot move along the object in the first direction.

In accordance with yet another aspect of the invention, a locking assembly for a linear clutch includes a first wedge having a first surface and a second surface opposite the first surface, with the second surface including a taper extending into the first wedge from the second surface toward the first surface. The locking assembly also includes a first spring configured to bias the first wedge and a first bearing assembly configured to fit within the taper of the first wedge and including a first roller bearing. Furthermore, the locking assembly includes a lever configured to engage the wedge and to move between an unlocked position and a locked position.

Various other features and advantages of the present invention will be made apparent from the following detailed description and the drawings.

### BRIEF DESCRIPTION OF THE DRAWINGS

The drawings illustrate embodiments presently contemplated for carrying out the invention.

In the drawings:

FIGS. 1 and 2 are top perspective views of a system for supporting and securing an object or machine with a plurality of linear clutches in an unlocked state and a locked state, respectively, according to an embodiment of the invention.

FIG. 3 is a left-side view of the system of FIGS. 1 and 2 with the plurality of linear clutches in the locked state, as shown in FIG. 2, according to an embodiment of the invention.

FIG. 4 is a top perspective view of a first one-way linear clutch used in the system of FIGS. 1-3, according to an embodiment of the invention.

FIG. 5 is a bottom perspective view of the first one-way linear clutch of FIG. 4, according to an embodiment of the invention.

FIG. 6 is an exploded perspective view of a one-way locking assembly of the first one-way linear clutch of FIGS. 4 and 5, according to an embodiment of the invention.

FIGS. 7 and 8 are bottom views of the first one-way linear clutch of FIGS. 4 and 5 on a rail in the unlocked and locked states, respectively, and with the one-way locking assembly exposed, according to an embodiment of the invention.

FIG. 8 is a bottom view of the first one-way linear clutch of FIGS. 4 and 5 in the unlocked state on a rail and with the one-way locking assembly exposed, according to an embodiment of the invention.

FIG. 9 is a top perspective view of a second one-way linear clutch used in the system of FIGS. 1-3, according to an embodiment of the invention.

FIG. 10 is a bottom perspective view of the second one-way linear clutch of FIG. 9, according to an embodiment of the invention.

FIGS. 11 and 12 are cross-sectional views taken along line 11-11 of FIG. 10 showing the second one-way linear clutch of FIGS. 9 and 10 on a rail in the unlocked state and the locked state, respectively, according to an embodiment of the invention.

FIG. 13 is a top perspective view of a two-way linear clutch used in the system of FIGS. 1-3, according to an embodiment of the invention.

FIG. 14 is a bottom perspective view of the two-way linear clutch of FIG. 13, according to an embodiment of the invention.

FIG. 15 is a top perspective view of a clutch assembly of the two-way linear clutch of FIGS. 13 and 14, according to an embodiment of the invention.

FIGS. 16 and 17 are cross-sectional views taken along line 16-16 of FIG. 14 showing the two-way linear clutch of FIGS. 13 and 14 on a rail in the unlocked state and the locked state, respectively, according to an embodiment of the invention.

### DETAILED DESCRIPTION

Embodiments of the present invention provide for a linear clutch and method for making the same. The linear clutch includes a main body with a support panel section, first and second wall sections extending from the support panel section, and a channel extending therethrough. The first wall section includes a groove adjacent to the channel and at least one taper adjacent to the groove. The linear clutch also includes a locking assembly having at least one wedge, at least one bearing assembly, a lever, and at least one spring. Each wedge has a taper and is positioned within the groove such that its taper is adjacent to one taper of the first wall section in order to form a taper pocket. Each bearing assembly is positioned within one taper pocket. The lever is secured at the first wall section, and each spring biases one wedge to engage the lever. The lever is configured to switch the linear clutch between an unlocked state in which the linear clutch is able to move along an object in the channel in two directions and a locked state in which the linear clutch cannot move along the object in one of the two directions.

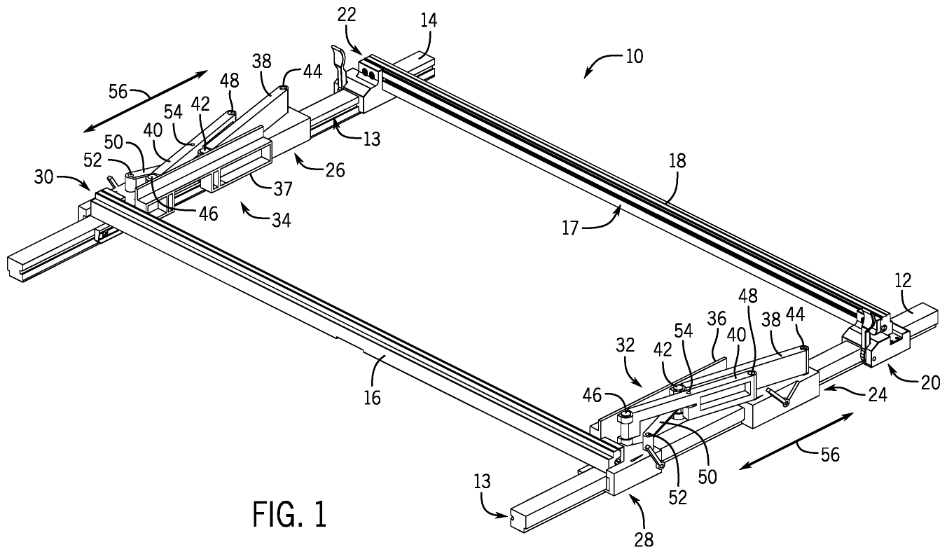

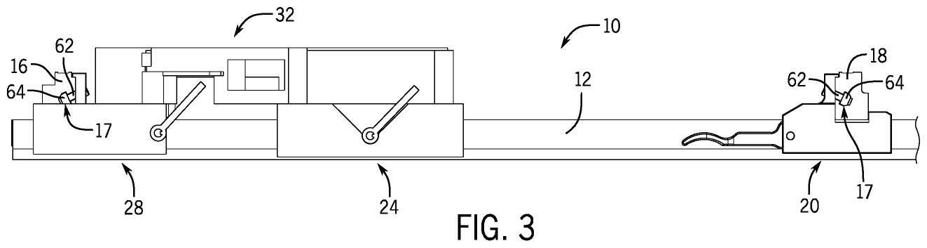

Referring to FIGS. 1-3, FIGS. 1 and 2 show top perspective views of a system 10 for supporting and securing an object or machine (not shown), and FIG. 3 shows a left-side view of system 10, according to an embodiment of the invention. System 10 includes left and right side rails 12, 14 having a groove 13 therein and front and rear cross rails 16, 18 having a groove 17 therein. Engaged with side rail 14, 16 are left and right-side one-way linear clutches 20, 22, left and right-side two-way linear clutches 24, 26, and left and right-side one-way linear clutches 28, 30. Front cross rail 16 is mounted on left and right-side one-way linear clutches 28, 30, and rear cross rail 18 is mounted on left and right-side one-way linear clutches 22, 24, as will be described in greater detail below.

Left-side two-way linear clutch 24 and one-way linear clutch 28 are coupled to a left-side adjustable side support system 32, and right-side two-way linear clutch 26 and one-way linear clutch 30 are coupled to a right-side adjustable side support system 34. Left-side and right-side adjustable side support systems 32, 34 include a respective bracket 36, 37 configured to provide support at a respective left or right side of an object or machine placed on cross rails 16, 18. Brackets 36, 37 are coupled to left and right-side two-way linear clutches 24, 26, respectively, by first and second linkage arms 38, 40 with respective pins 42, 44 and 46, 48. Left and right-side one-way linear clutches 28, 30 are coupled to the corresponding second linkage arm 40 by a corresponding third linkage arm 50 with pins 52, 54.

As shown via the different positions of left and right-side two-way linear clutches 24, 26, left and right-side one-way linear clutches 28, 30, and side support systems 32, 34, side support systems 32, 34 are adjustable via the movement of left and right-side two-way linear clutches 24, 26 and left and right-side one-way linear clutches 28, 30. That is, as left and right-side two-way linear clutches 24, 26 and left and right-side one-way linear clutches 28, 30 move, so do linkage arms 38, 40, 50. In order to make the adjustment, a user will place either left and right-side two-way linear clutches 24, 26 or left and right-side one-way linear clutches 28, 30 in the desired position and place them into the locked state. Thereafter, the user will place the other of left and right-side two-way linear clutches 24, 26 or left and right-side one-way linear clutches 28, 30 in the desired position and place them into the locked state.

However, while side support systems 32, 34 are illustrated in use with left and right-side two-way linear clutches 24, 26 and left and right-side one-way linear clutches 28, 30, side support systems 32, 34 are not so limited. As non-limiting examples, side support systems 32, 34 may be used two sets of left and right-side one-way linear clutches 28, 30 or two sets of left and right-side two-way linear clutches 24, 26. Similarly, system 10 overall may have a different number and combination of linear clutches 20, 22, 24, 26, 28, 30 and is not limited to the specific configuration shown in FIGS. 1-3.

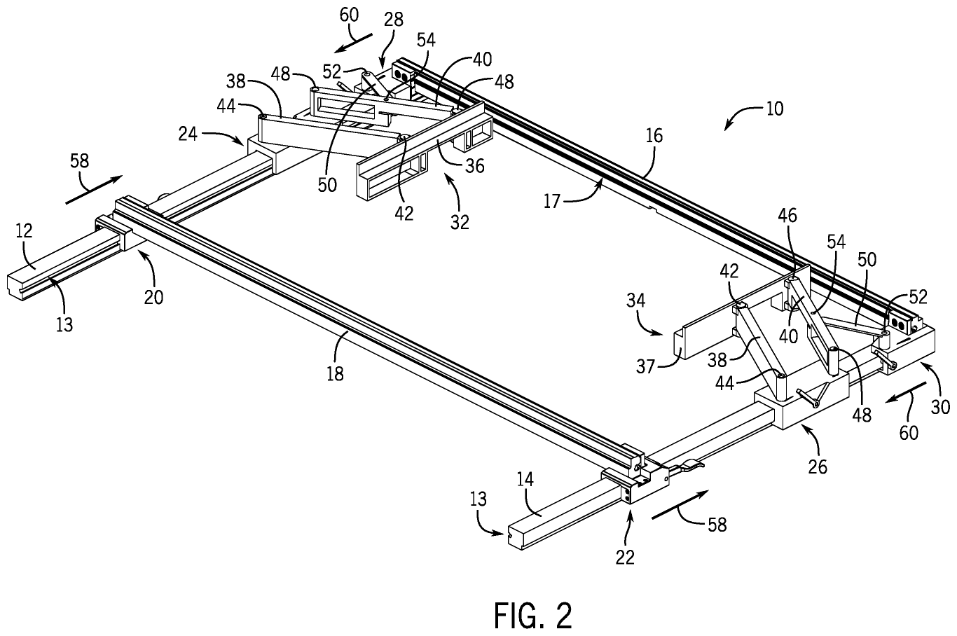

With respect to the unlocked and locked states of linear clutches 20, 22, 24, 26, 28, 30, FIGS. 1 and 2 shown the different states. In FIG. 1, each linear clutch 20, 22, 24, 26, 28, 30 is in an unlocked state that allows each linear clutch 20, 22, 24, 26, 28, 30 to move in either direction on the corresponding side rail 12, 14, as shown by way of bidirectional arrows 56. In FIG. 2, each linear clutch 20, 22, 24, 26, 28, 30 is in a locked state that prevents movement of each linear clutch 20, 22, 24, 26, 28, 30 on the corresponding side rail 12, 14 in at least one direction. When left and right-side one-way linear clutches 22, 24 are in the locked state, they can only move toward cross rail 16, as shown by unidirectional arrows 58. When left and right-side two-way linear clutches 26, 28 are in the locked state, they cannot move in either direction. When left and right-side one-way linear clutches 28, 30 are in the locked state, they can only move toward cross rail 18, as shown by unidirectional arrows 60. Thus, one-way linear clutches 22, 24, 28, 30 may be considered one-way locks, and two-way linear clutches 24, 26 may be considered two-way locks.

When moving in either the unlocked or locked states, left and right-side one-way linear clutches 22, 24 carry cross rail 18, and left and right-side one-way clutches 28, 30 carry cross rail 16, as cross rails 16, 18 are mounted thereon. As shown most clearly in FIG. 3, cross rails 16, 18 are mounted on left and right-side one-way clutches 28, 30 and left and right-side one-way linear clutches 22, 24, respectively, via fasteners 62 extending into groove 13 and engaging a retaining bar or elongated nut 64 on each cross rail 16, 18. When fasteners 62 are threaded into retaining bars 64 and sufficiently tightened, cross rails 16, 18 will be mounted on left and right-side one-way clutches 28, 30 and left and right-side one-way linear clutches 22, 24, respectively. The structure and operation of linear clutches 20, 22, 24, 26, 28, 30 and the mounting of cross rails 16, 18 to left and right-side one-way linear clutches 28, 30 and linear clutches 20, 22, respectively, will be described in more detail below.

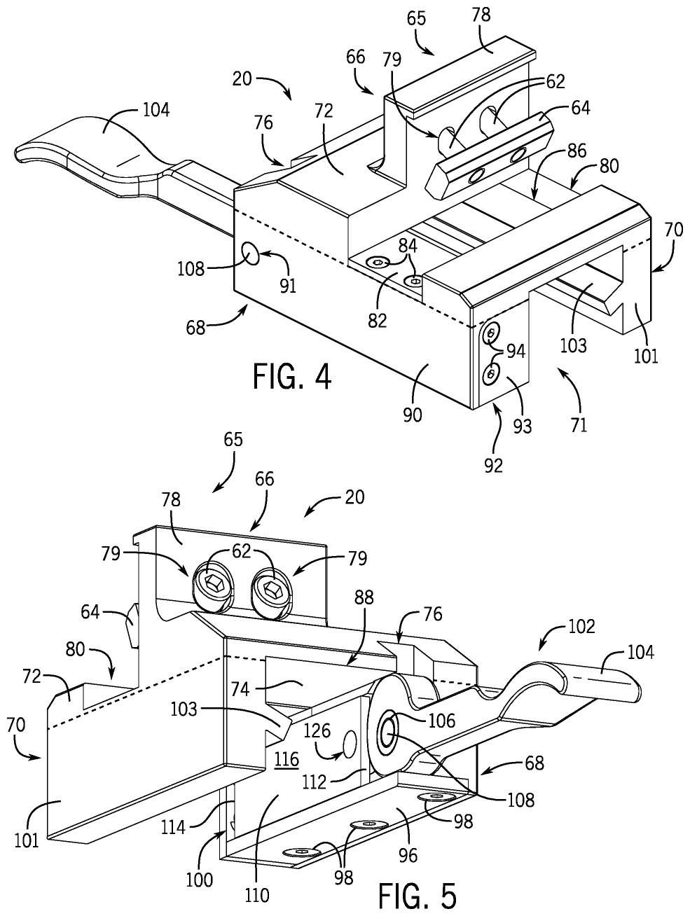

The structure and operation of left and right-side one-way linear clutches 20, 22 will now described further with respect to FIGS. 4-8. Since left and right-side one-way linear clutches 20, 22 have the exact same structure and operation with parts reversed to engage opposite side rails 14, 16, only left-side one-way linear clutch 20 is shown and described. As such, any description of left-side one-way linear clutch 20 is applicable to right-side one-way linear clutch 22. Left-side one-way linear clutch 20 will be referred to as linear clutch 20 hereinafter.

Referring first to FIGS. 4 and 5, top and bottom perspective views of linear clutch 20 are shown, according to an embodiment of the invention. Linear clutch 20 includes a main body or frame 65 having a support panel section 66, a first wall section 68, a second wall section 70, and a channel 71 extending therethrough. Support panel section 66 includes an outer side 72 and an inner side 74 opposite outer side 72. Outer side 72 of support panel section 66 includes a front notch 74 formed therein. Outer side 72 also includes a mounting flange 78 with openings 79 configured to receive fasteners 62 that engage retaining bar 74, as most clearly shown in FIG. 4. Outer side 72 also includes a groove 80 extending across outer side 72 adjacent to mounting flange 78. Groove 80 is configured to receive cross rail 18 shown in FIG. 1. Within groove 80, outer side 72 includes a bearing cover 84 mounted to first side wall section 68 via fasteners 84 and also an opening 86 formed through outer side 72 and into channel 71. Inner side 74 of support panel section 66 includes a notch 88 therein that defines or forms one side of channel 71.

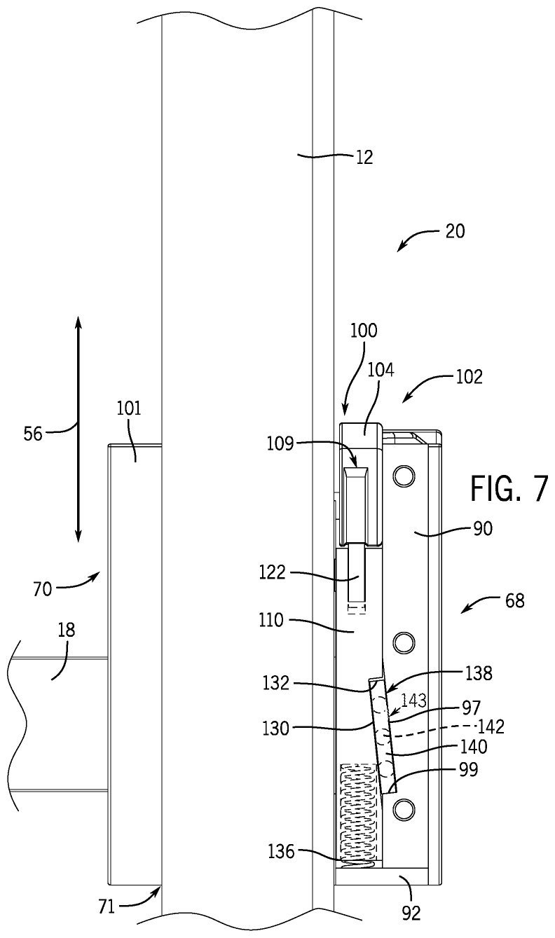

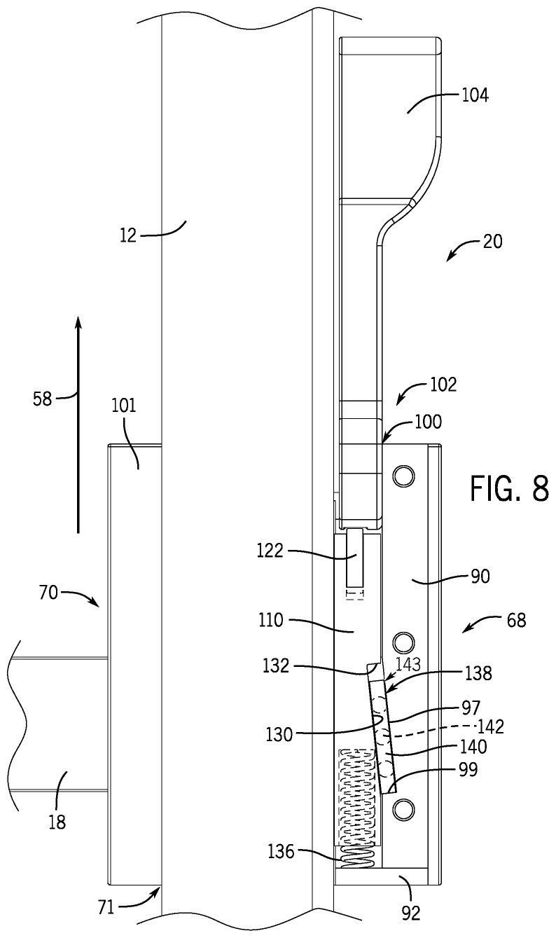

First wall section 68 extends from support panel section 66 and includes a side wall 90 including an opening 91 extending therethrough. First wall section 68 additionally includes a rear wall 92 including a rear cover 93 mounted to side wall 90 via fasteners 94. Furthermore, first wall section 68 includes a base wall 96 mounted to side wall 90 via fasteners 98. The arrangement of side wall 90, rear wall 92, and base wall 96 creates a groove 100 in first wall section 68. Groove 100 is positioned adjacent channel 71, and rear wall 92 and base wall 96 define or form part of channel 71. Side wall 90 further includes a taper 97 (FIGS. 7 and 8) adjacent to groove 100. Taper 97 extends away from groove 100 into side wall 90 until reaching a taper end wall or datum 99 (FIGS. 7 and 8).

Second wall section 70 of main body 65 extends from support panel section 66 at a location spaced apart from first wall section 68. Second wall section 70 includes a side wall 101 that defines or forms one side of channel 71. Side wall 101 includes a projection 103 extending into channel 71 that is configured to engage groove 17 of side rail 12, as shown in FIGS. 1 and 2. However, projection 103 is optional and is not necessary for operation of linear clutch 22. Projection 103 may also be arranged in a different manner than that shown such as, for example, with a different size and/or shape. Further, while main body 65 of linear clutch 22 has been shown and described as having multiple different sections with separate parts, this configuration of main body 65 is non-limiting. That is, in various embodiments, main body 65 may be formed in a different manner. As a non-limiting example, all of main body may be formed as an integral unit with all components being made from the same unit of material. Furthermore, in some embodiments, various components shown and described separately above may be formed integrally while other components are not. Also, while linear clutch 20 has been shown in use with side rail 12 and cross rail 18, linear clutch 20 may be configured for use on other objects such as a table or work bench, as non-limiting examples.

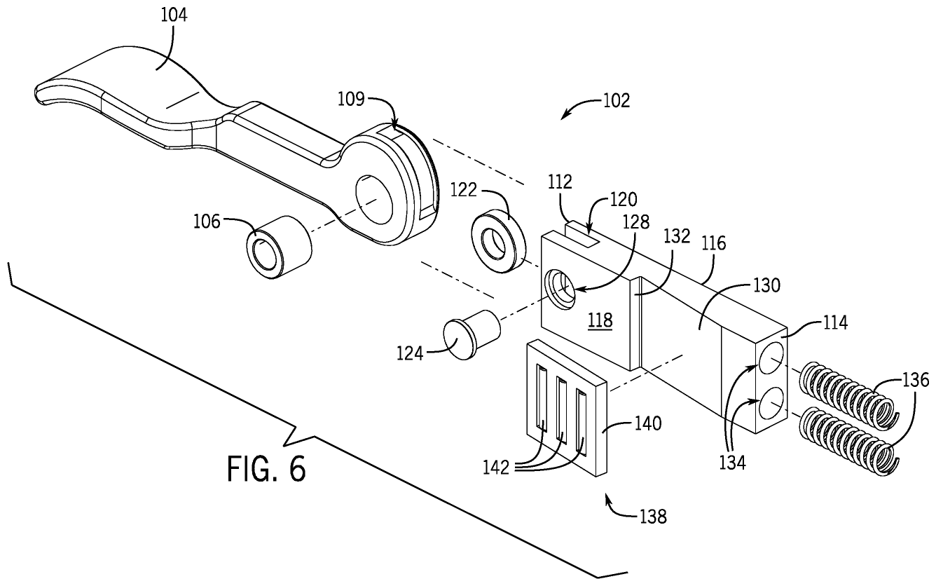

In addition to main body 65, linear clutch 22 includes a one-way locking or clutching assembly 102. Referring now to FIG. 6 in addition to FIGS. 4 and 5, an exploded view of one-way locking assembly 102 is shown, according to an embodiment of the invention. Locking assembly 102 includes a lever or handle 104 that is configured to switch linear clutch 22 between the unlocked state, as shown previously in FIG. 1, and the locked state, as shown previously in FIG. 2. In FIGS. 4 and 5, lever 104 has been rotated downward such that it points straight out of groove 100 in the direction of unidirectional arrow 58 (see FIGS. 2, 7, and 8). This position of lever 104 is a locked position that puts linear clutch 22 in the locked state. Lever 104 is in an unlocked position when it is rotated upward such that it points away from base wall 96 of first wall section 68 and is received within notch 76 of support panel section 66. Lever 104 includes a handle bearing 106 positioned therein and is secured at side wall 90 of first wall section 68 via a pin 108 extending through lever 104 and opening 91 in side wall 90. Lever 104 also includes a groove 109 therein. Lever 104 also has a variable radius that allows it to control the amount of space in groove 100 of first wall section 68.

Locking assembly 102 further includes a wedge 110 with first and second ends 112, 114 and first and second surfaces 116, 118. First end 112 of wedge 110 includes a notch 120 sized to receive a roller drive 122 coupled to wedge 110 for engaging groove 109 of lever 104. Roller drive 122 is coupled to wedge 110 via a pin 124 received through openings 126, 128 in surfaces 116, 118, respectively, adjacent to first end 112 of wedge 110. Wedge 110 also includes a taper 130 that extends from surface 118 toward surface 116 until reaching a taper end wall or datum 132. Second end 114 of wedge 110 includes openings 134 sized to receive springs 136 that bias wedge 110 toward lever 104 to engage lever 104. Locking assembly 102 additionally includes a roller bearing assembly 138 having a roller cage 140 with three roller bearings 142 positioned therein.

Referring now to FIGS. 7 and 8, bottom views of linear clutch 20 in the unlocked and locked states are shown with base wall 96 removed, according to an embodiment of the invention. Initially, as shown in FIGS. 7 and 8, when locking assembly 102 is positioned within groove 100 of first wall section 68, taper 97 of side wall 90 of first wall section 68 and taper 130 of wedge 110 of locking assembly 102 are aligned to form a taper pocket 143. Roller bearing assembly 138 is positioned within taper pocket 143. The size and shape of taper pocket 143 with respect to roller bearing assembly 138 determines whether linear clutch 20 is in the locked or unlocked state, and actuation of lever 104 is what triggers the size and shape of taper pocket 143 to change. That is, the position of lever 104 controls the position of wedge 110 in groove 100 and, therefore, the alignment of taper 97 and taper 130. The change in alignment between taper 97 and taper 130 changes the size and shape of taper pocket 143.

Referring now to FIG. 7, when linear clutch 20 is in the unlocked state, lever 104 is in the unlocked position pointing away from base wall 96 (not shown). Lever 104 is engaged with wedge 110 via roller drive 122, with roller drive 122 being positioned within groove 109 of lever 104. When lever 104 moves into this position, the portion of lever 104 with a larger radius engages roller drive 122 such that lever 104 takes up more space in groove 100. This causes wedge 110 to move toward rear wall 92 of first wall section 68 and compress springs 136. It also causes wedge 110 to push roller bearing assembly 138 back to taper end wall 99 of side wall 90, which may be considered a starting position. Once wedge 110 reaches the position shown in FIG. 7, taper 97 and taper 130 are aligned such that taper pocket 143 has a substantially consistent size and shape throughout. This configuration of taper pocket 143 allows roller bearings 142 in roller bearing assembly 138 to rotate freely within taper pocket 143 regardless of which direction linear clutch 20 is moving, as indicated by bidirectional arrow 56. As such, linear clutch 20 is in the unlocked state in FIG. 7.

Referring now to FIG. 8, when linear clutch 20 is in the locked state, lever 104 is in the locked position extending straight out of groove 100 in the direction of unidirectional arrow 58. When lever 104 moves into this position, the portion of lever 104 with a smaller radius engages roller drive 122 such that lever 104 takes up less space in groove 100. This causes springs 136 to expand and push wedge 110 away from rear wall 92. Once wedge 110 reaches this position, as shown in FIG. 8, taper 97 and taper 130 are aligned such that taper pocket 143 is narrower near taper end wall 99 than near taper end wall 132. This configuration of taper pocket 143 allows roller bearings 142 to rotate freely within taper pocket 143 when linear clutch 20 moves in the direction indicated by unidirectional arrow 58. However, if a user tries to move linear clutch 20 in the opposite direction, roller bearings 142 become pinched due to the friction between taper 97 and taper 132 in this narrower section of taper pocket 143. Thus, roller bearings 142 cannot rotate, and linear clutch 20 cannot move in that direction. As such, linear clutch 20 is in the locked state in FIG. 8.

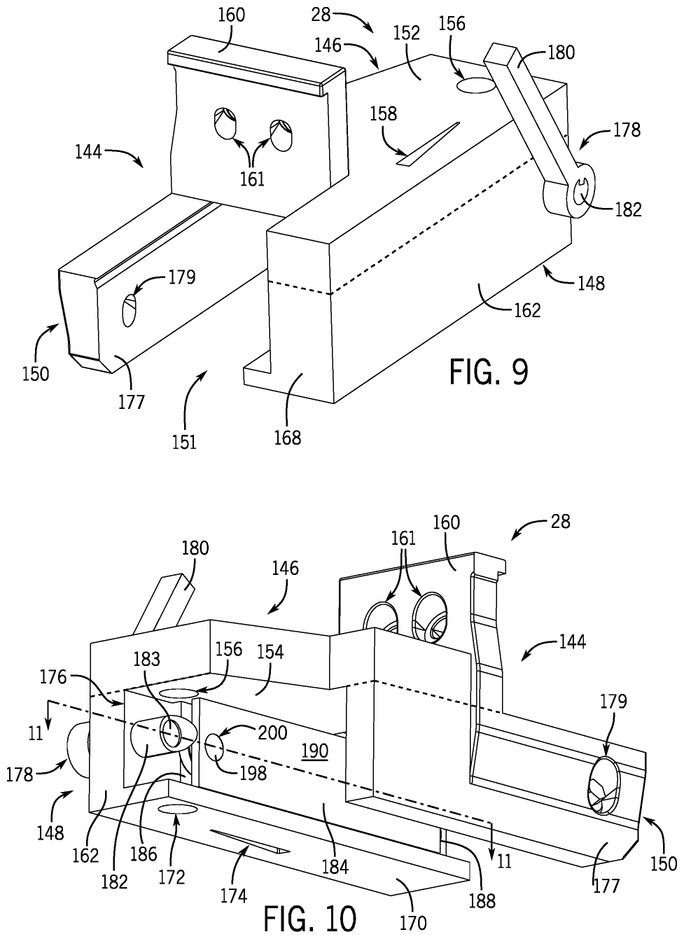

The structure and operation of left and right-side one-way linear clutches 28, 30 will now described further with respect to FIGS. 9-12. Since left and right-side one-way linear clutches 28, 30 have the exact same structure and operation with parts reversed to engage opposite side rails 14, 16, only left-side one-way linear clutch 28 is shown and described. As such, any description of left-side one-way linear clutch 28 is applicable to right-side one-way linear clutch 30. Left-side one-way linear clutch 28 will be referred to as linear clutch 28 hereinafter.

Referring first to FIGS. 9 and 10, top and bottom perspective views of linear clutch 28 are shown, according to an embodiment of the invention. Linear clutch 28 includes a main body or frame 144 having a support panel section 146, a first wall section 148, a second wall section 150, and a channel 151 extending therethrough. Support panel section 146 includes an outer side 152 and an inner side 154 opposite outer side 152. Outer side 152 of support panel section 146 includes an opening 156 configured to receive pin 52, as shown in FIGS. 1 and 2, and an opening 158 therethrough adjacent to first wall section 148. Outer side 152 of support panel section 146 also includes a mounting flange 160 with openings 161 configured to receive fasteners 62 that engage retaining bar 74, as previously shown in FIGS. 1-3. Mounting flange 160 enables cross rail 16 of FIGS. 1-3 to mount to linear clutch 28 when positioned adjacent to mounting flange 160 and to channel 151. In that case, cross rail 16 would define or form part of one side of channel 151. Inner side 154 of support panel section 146 defines or forms one side of channel 151.

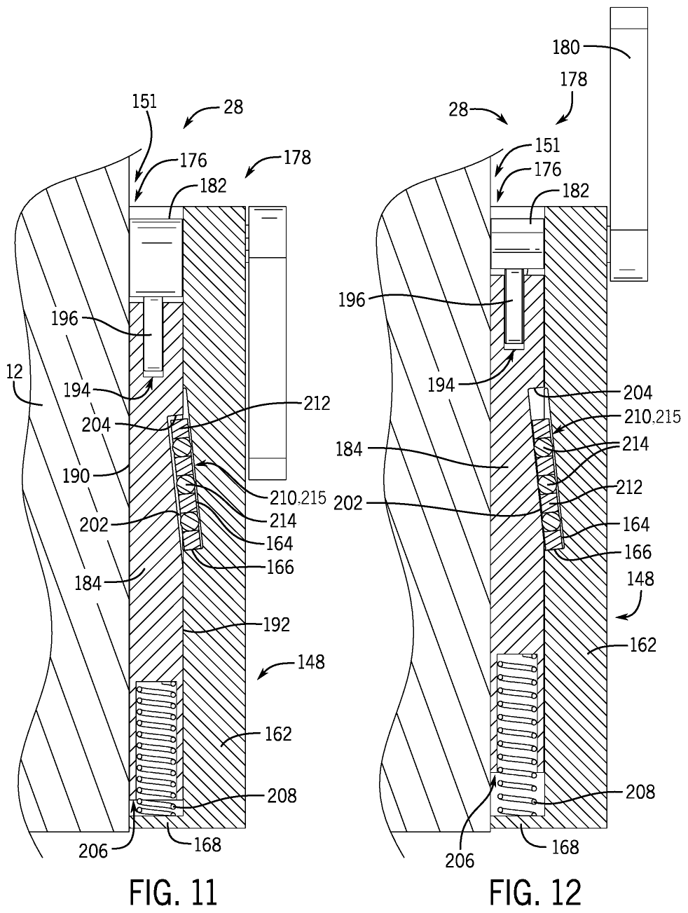

First wall section 148 extends from support panel section 146 and includes a side wall 162 having a taper 164 (FIGS. 11 and 12) extending into a taper end wall or datum 166 (FIGS. 11 and 12) in a similar manner to that of taper 97 and taper end wall 99 of side wall 90 of first wall section 68 of linear clutch 20 (FIGS. 7-8). First wall section 148 also includes a rear wall 168 and a base wall 170, which includes openings 172, 174 matching openings 156, 158 in support panel section 146. Opening 172 would allow linear clutch 28 to receive pin 52 shown in FIGS. 1 and 2 instead of in opening 156. The arrangement of side wall 162, rear wall 168, and base wall 170 creates a groove 176 in first wall section 148. Groove 176 is positioned adjacent channel 151, and rear wall 168 and base wall 170 define or form part of channel 151.

Second wall section 150 of main body 144 extends from support panel section 144 at a location spaced apart from first wall section 146. Second wall section 148 includes a side wall 177 that defines or forms one side of channel 151. Side wall 177 includes an opening 179 therein for receiving a pin or other type projection configured to engage groove 17 of side rail 12, as shown in FIGS. 1 and 2. Alternatively, side wall 177 may not include opening 179 and/or include a projection (not shown) extending into channel 151 in a similar manner to that of projection 103 of side wall 101 of second wall section 70 of linear clutch 20 (FIGS. 4 and 5). Further, while main body 144 of linear clutch 28 is shown as an integral unit in FIGS. 9 and 10, main body 144 may be formed in a different manner. As a non-limiting example, main body 144 may include separately connected components in various embodiments, depending on the desired configuration of main body 144. Also, while linear clutch 28 has been shown in use with side rail 12 and cross rail 16, linear clutch 28 may be configured for use on other objects such as a table or work bench, as non-limiting examples.

In addition to main body 144, linear clutch 28 includes a one-way locking or clutching assembly 178. Referring now to FIGS. 11 and 12 in addition to FIGS. 9 and 10, cross-section views of linear clutch 28 taken along line 11-11 in FIG. 10 are shown with linear clutch 28 in the unlocked state and the locked state, respectively, according to an embodiment of the invention. Locking assembly 178 includes a lever or handle 180 that is configured to switch linear clutch 28 between the unlocked state, as shown previously in FIG. 1, and the locked state, as shown previously in FIG. 2. Lever 180 is coupled to a cam 182 extending through side wall 162 of first wall section 148 and is thus secured at side wall 162.

Locking assembly 178 further includes a wedge 184 with first and second ends 186, 188 and first and second surfaces 190, 192. First end 186 of wedge 184 includes a notch 194 sized to receive a roller drive 196 coupled to wedge 184 for engaging lever 180 via cam 182. Roller drive 196 is coupled to wedge 184 via a pin 198 received through openings 200 in surfaces 190, 192 adjacent to first end 186 of wedge 184. Wedge 184 also includes a taper 202 that extends from surface 192 toward surface 190 until reaching a taper end wall or datum 204. Second end 188 of wedge 184 includes openings 206 sized to receive springs 168 that bias wedge 184 toward lever 180 to engage lever 180 via cam 182. Locking assembly 178 additionally includes a roller bearing assembly 210 having a roller cage 212 with three roller bearings 214 positioned therein.

Referring still to FIGS. 11 and 12, when locking assembly 178 is positioned within groove 176 of first wall section 148, taper 164 of side wall 162 of first wall section 148 and taper 202 of wedge 184 of locking assembly 178 are aligned to form a taper pocket 215. Roller bearing assembly 210 is positioned within taper pocket 215. The size and shape of taper pocket 215 with respect to roller bearing assembly 210 determines whether linear clutch 28 is in the locked or unlocked state, and actuation of lever 180 is what triggers the size and shape of taper pocket 215 to change. That is, the position of lever 180 controls the position of wedge 184 in groove 176 and, therefore, the alignment of taper 164 and taper 202. The change in alignment between taper 164 and taper 202 changes the size and shape of taper pocket 215.

Referring now to FIG. 11, when linear clutch 28 is in the unlocked state, lever 180 is in the unlocked position pointing toward mounting flange 160 (FIG. 9). Lever 180 is engaged with wedge 184 via roller drive 122 and cam 182, with roller drive 122 being positioned against cam 182. When lever 180 moves into this position, the portion of cam 182 with a larger radius engages roller drive 122 such that the engaged portion of cam 182 is longer within groove 176. This causes wedge 184 to move toward rear wall 168 of first wall section 148 and compress springs 208. It also causes wedge 184 to push roller bearing assembly 210 back to taper end wall 166 of side wall 162, which may be considered a starting position. Once wedge 184 reaches the position shown in FIG. 11, taper 164 and taper 202 are aligned such that taper pocket 215 has a substantially consistent size and shape throughout. This configuration of taper pocket 215 allows roller bearings 214 in roller bearing assembly 210 to rotate freely within taper pocket 215 regardless of which direction linear clutch 28 is moving, as indicated by bidirectional arrow 56 (FIG. 1). As such, linear clutch 28 is in the unlocked state in FIG. 11.

Referring now to FIG. 12, when linear clutch 28 is in the locked state, lever 180 is in the locked position point away from mounting flange 160. When lever 180 moves into this position, the portion of cam 182 with a smaller radius engages roller drive 122 such that the engaged portion of cam 182 is shorter within groove 176. This causes springs 208 to expand and push wedge 184 away from rear wall 168. Once wedge 184 reaches this position, as shown in FIG. 12, taper 164 and taper 202 are aligned such that taper pocket 205 is narrower near taper end wall 166 than near taper end wall 204. This configuration of taper pocket 215 allows roller bearings 214 to rotate freely within taper pocket 215 when linear clutch 28 moves in the direction indicated by unidirectional arrow 60 (FIG. 1). However, if a user tries to move linear clutch 28 in the opposite direction, roller bearings 214 become pinched due to the friction between taper 164 and taper 202 in this narrower section of taper pocket 215. Thus, roller bearings 214 cannot rotate, and linear clutch 28 cannot move in that direction. As such, linear clutch 28 is in the locked state in FIG. 12.

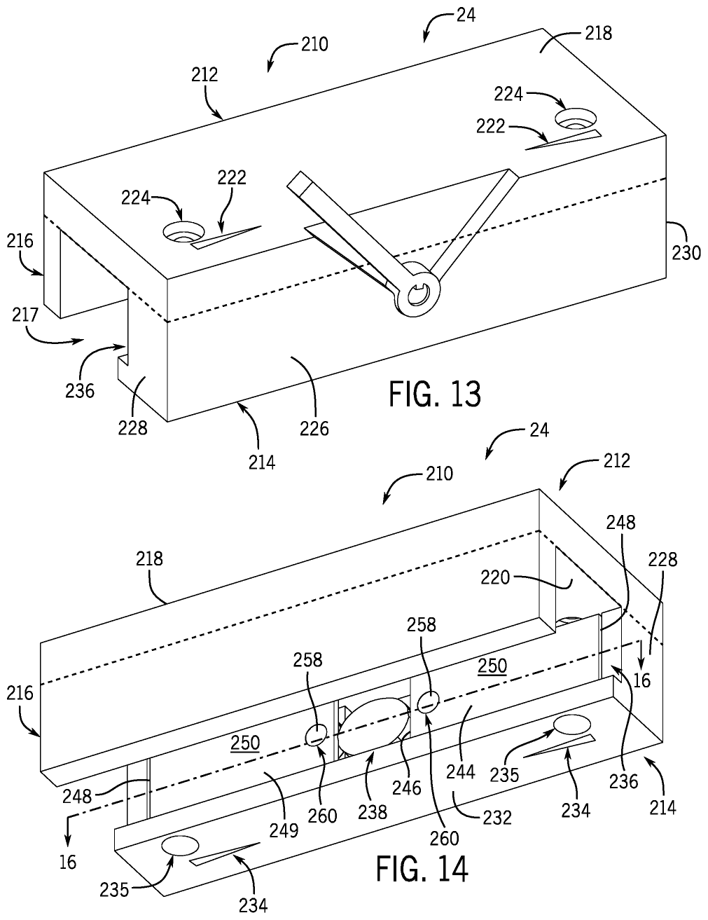

The structure and operation of left and right-side two-way linear clutches 24, 26 will now described further with respect to FIGS. 13-17. Since left and right-side two-way linear clutches 24, 26 have the exact same structure and operation with parts reversed to engage opposite side rails 14, 16, only left-side two-way linear clutch 24 is shown and described. As such, any description of left-side two-way linear clutch 24 is applicable to right-side two-way linear clutch 26. Left-side two-way linear clutch 24 will be referred to as linear clutch 24 hereinafter.

Referring first to FIGS. 13 and 14, top and bottom perspective views of linear clutch 24 are shown, according to an embodiment of the invention. Linear clutch 24 includes a main body or frame 210 having a support panel section 212, a first wall section 214, a second wall section 216, and a channel 217 extending therethrough. Support panel section 212 includes an outer side 218 and an inner side 220 opposite outer side 218. Outer side 218 of support panel section 212 includes openings 224 configured to receive pins 44, 48, as shown in FIGS. 1 and 2, and openings 222 therethrough adjacent to first wall section 214.

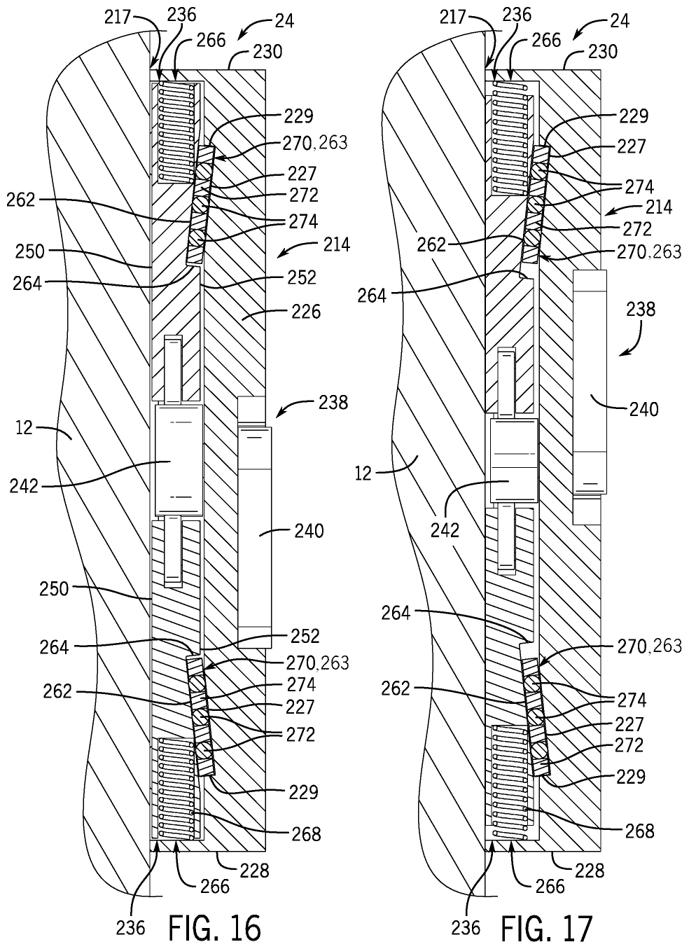

First wall section 214 extends from support panel section 212 and includes a side wall 226 having two tapers 227 (FIGS. 16 and 17) extending into taper end walls or datums 229 (FIGS. 16 and 17) in a similar manner to that of taper 97 and taper end wall 99 of side wall 90 of first wall section 68 of linear clutch 20 (FIGS. 7-8) and taper 164 and taper end wall 166 of side wall 162 of first wall section 148 in linear clutch 28 (FIGS. 11 and 12). First wall section 214 also includes a rear wall 228, a front wall 230, and a base wall 232, which includes openings 234, 235 matching openings 222, 224 in support panel section 212. Openings 235 would allow linear clutch 24 to receive pins 44, 48 shown in FIGS. 1 and 2 instead of in openings 224. The arrangement of side wall 226, rear wall 228, front wall 230, and base wall 232 creates a groove 236 in first wall section 214. Groove 236 is positioned adjacent channel 217, and rear wall 228, front wall 230, and base wall 232 define or form part of channel 217.

Second wall section 216 of main body 210 extends from support panel section 212 at a location spaced apart from first wall section 212. Second wall section 214 includes a side wall that defines or forms one side of channel 217. While not shown in FIGS. 13 and 14, second wall section 214 may include an opening (not shown) similar to that of opening 179 in side wall 177 of second wall section 150 of linear clutch 28 (FIGS. 9 and 10) and/or a projection (not shown) extending into channel 217 in a similar manner to that of projection 103 of side wall 101 of second wall section 70 of linear clutch 20 (FIGS. 4 and 5). Further, while main body 210 of linear clutch 24 is shown as an integral unit in FIGS. 13 and 14, main body 210 may be formed in a different manner. As a non-limiting example, main body 210 may include separately connected components in various embodiments, depending on the desired configuration of main body 210. Also, while linear clutch 24 has not been shown in use with a cross rail, linear clutch 24 may include a mounting flange (not shown) similar to that of mounting flange 78 of support panel section 66 of linear clutch 20 (FIG. 1) or mounting flange 160 of support panel section 146 of linear clutch 28 (FIGS. 9 and 10). Furthermore, while linear clutch 24 is shown in use with side rail 12 of FIG. 12, linear clutch 24 may be configured for use on other objects such as a table or work bench, as non-limiting examples.

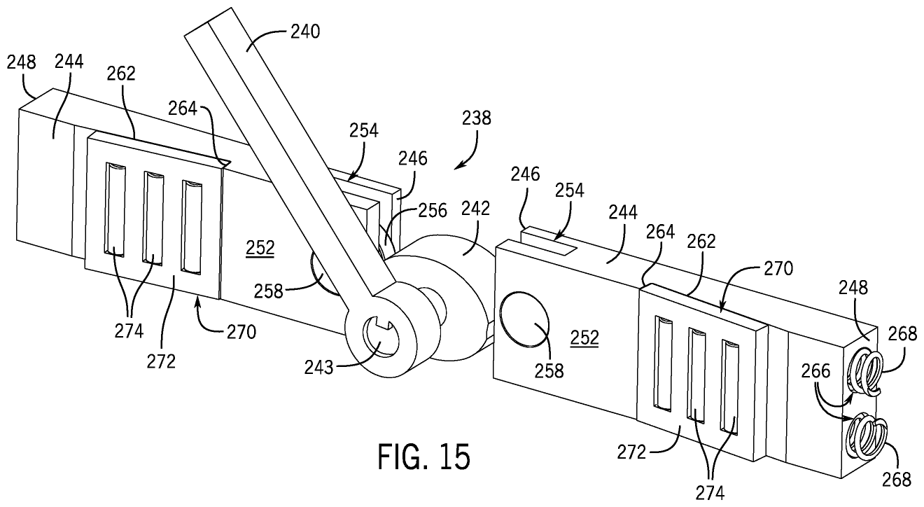

In addition to main body 210, linear clutch 24 includes a two-way locking or clutching assembly 238. Referring now to FIG. 15 in addition to FIGS. 13 and 14, a perspective view of two-way locking assembly 238 is shown, according to an embodiment of the invention. Locking assembly 238 includes a lever or handle 240 that is configured to switch linear clutch 24 between the unlocked state, as shown previously in FIG. 1, and the locked state, as shown previously in FIG. 2. Locking assembly 238 includes a lever or handle 240 that is configured to switch linear clutch 24 between the unlocked state, as shown previously in FIG. 1, and the locked state, as shown previously in FIG. 2. Lever 240 is coupled to a cam 242 extending through side wall 226 of first wall section 214 via pin 243 and is thus secured at side wall 226.

Locking assembly 238 further includes first and second wedges 244 with first and second ends 246, 248 and first and second surfaces 250, 252. First ends 246 of wedges 244 include notches 254 sized to receive roller drives 256 coupled to wedges 244 for engaging lever 240 via cam 242. Roller drives 256 are coupled to wedges 244 via pins 258 received through openings 260 in surfaces 250, 252 adjacent to first ends 246 of wedges 244. Wedges 244 also include tapers 262 that extend from surfaces 252 toward surfaces 250 until reaching taper end walls or datums 264. Second ends 248 of wedge 244 include openings 266 sized to receive springs 268 that bias wedges 244 toward lever 240 to engage lever 240 via cam 242. Locking assembly 238 additionally includes roller bearing assemblies 270 having roller cages 272 with three roller bearings 274 positioned therein.

Referring now to FIGS. 16 and 17, cross-section views of linear clutch 24 taken along line 16-16 in FIG. 14 are shown with linear clutch 24 in the unlocked state and the locked state, respectively, according to an embodiment of the invention. When locking assembly 238 is positioned within groove 236 of first wall section 214, tapers 227 of side wall 226 of first wall section 214 and tapers 262 of wedges 244 of locking assembly 238 are aligned to form taper pockets 263. Roller bearing assemblies 270 is positioned within taper pockets 263. The size and shape of taper pockets 263 with respect to roller bearing assemblies 270 determines whether linear clutch 24 is in the locked or unlocked state, and actuation of lever 240 is what triggers the size and shape of taper pockets 263 to change. That is, the position of lever 240 controls the position of wedges 244 in groove 236 and, therefore, the alignment of tapers 227 and tapers 262. The change in alignment between tapers 227 and tapers 262 changes the size and shape of taper pockets 263.

Referring now to FIG. 16, when linear clutch 24 is in the unlocked state, lever 240 is in the unlocked position rotated counterclockwise with respect to sidewall 226 of first wall section 214. Lever 240 is engaged with wedges 244 via roller drives 256 and cam 242, with roller drives 256 being positioned against cam 242. When lever 240 moves into this position, the portion of cam 242 with a larger radius engages roller drives 256 such that the engaged portion of cam 242 is longer within groove 236. This causes wedges 244 to move toward rear wall 228 and front wall 230, respectively, of first wall section 214 and compress springs 268. It also causes wedges 244 to push roller bearing assemblies 270 back to taper end walls 229 of side wall 226, which may be considered a starting position. Once wedges 244 reach the positions shown in FIG. 16, tapers 227 and tapers 262 are aligned such that taper pockets 263 have a substantially consistent size and shape throughout. This configuration of taper pockets 263 allows roller bearings 274 in roller bearing assemblies 270 to rotate freely within taper pockets 263 regardless of which direction linear clutch 24 is moving, as indicated by bidirectional arrow 56 (FIG. 1). As such, linear clutch 24 is in the unlocked state in FIG. 16.

Referring now to FIG. 17, when linear clutch 24 is in the locked state, lever 240 is in the locked position rotated clockwise with respect to sidewall 226 of first wall section 214. When lever 180 moves into this position, the portion of cam 242 with a smaller radius engages roller drives 256 such that the engaged portion of cam 242 is shorter within groove 236. This causes springs 268 to expand and push wedges 244 away from rear wall 229 and front wall 230, respectively. Once wedges 244 reach this position, as shown in FIG. 17, tapers 227 and tapers 262 are aligned such that taper pockets 263 are narrower near taper end walls 229 than near taper end walls 264. This configuration of taper pockets 263 prevents movement of linear clutch 24 in either direction because roller bearings 274 in one of wedges 244 become pinched due to the friction between taper 227 and taper 262 in this narrower section of taper pocket 263 in each direction of movement. Thus, at least one set of roller bearings 274 cannot rotate, and linear clutch 24 cannot move in any direction. As such, linear clutch 24 is in the locked state in FIG. 17.

Beneficially embodiments of the invention thus provide a linear clutch including a main body with a support panel section, first and second wall sections extending from the support panel section, and a channel extending therethrough. The first wall section includes a groove adjacent to the channel and at least one taper adjacent to the groove. The linear clutch also includes a locking assembly having at least one wedge, at least one bearing assembly, a lever, and at least one spring. Each wedge has a taper and is positioned within the groove such that its taper is adjacent to one taper of the first wall section in order to form a taper pocket. Each bearing assembly is positioned within one taper pocket. The lever is secured at the first wall section, and each spring biases one wedge to engage the lever. The lever is configured to switch the linear clutch between an unlocked state in which the linear clutch is able to move along an object in the channel in two directions and a locked state in which the linear clutch cannot move along the object in one of the two directions. This configuration of a linear clutch provides an easy, convenient, reliable and efficient manner for a user to adjust the position of an object or machine. Simple movement of a lever is all it requires to use this linear clutch. Further, with the springs biasing the wedges toward the lever, putting a linear clutch in the locked position is a quick action.

Therefore, according to one embodiment of the invention, a linear clutch including a main body having a support panel section with an outer side and an inner side opposite the outer side. The main body also includes a first wall section extending from the inner side of the support panel section. The first wall section includes a groove adjacent to the inner side of the support panel section and a first taper adjacent to and extending away from the groove. Further, the main body includes a second wall section extending from the inner side of the support panel section and spaced apart from the first wall section. Additionally, the main body includes a channel extending through the main body adjacent to the groove of the first wall section and defined by the second wall section and the inner side of the support panel section. The channel is configured to receive an object therethrough such that the linear clutch is movable along the object in a first direction and a second direction. Furthermore, the linear clutch includes a locking assembly configured to engage the groove and the taper of the first wall section. The locking assembly includes a first wedge positioned within the groove of the first wall section. The first wedge includes a first surface adjacent to the channel and a second surface opposite the first surface, the second surface comprising a taper extending into the first wedge from the second surface toward the first surface and positioned adjacent to the first taper of the first wall section to form a first taper pocket. A first bearing assembly of the locking assembly is positioned within the first taper pocket and includes a first roller bearing. In addition, the locking assembly includes a lever secured at the first wall section and engaged with the wedge. The lever is configured to switch the linear clutch between an unlocked state in which the linear clutch is able to move along the object in the first direction and the second direction and a locked state in which the linear clutch cannot move along the object in the first direction. The locking assembly further includes a first spring biasing the first wedge to engage the lever.

According to another embodiment of the present invention, a method of manufacturing a linear clutch includes providing a main body. The main body includes a support panel section comprising an outer side and an inner side opposite the outer side. In addition, the main body includes a first wall section extending from the inner side of the support panel section and including a groove adjacent to the inner side of the support panel section and a first taper adjacent to and extending away from the groove. The main body further includes a second wall section extending from the inner side of the support panel section and spaced apart from the first wall section. The main body additionally includes a channel extending through the main body adjacent to the groove of the first wall section and defined by the second wall section and the inner side of the support panel. The channel is configured to receive an object therethrough such that the linear clutch is movable along the object in a first direction and a second direction. Furthermore, the method includes installing a locking assembly onto the main body by securing a lever at the first wall section and installing a first bearing assembly comprising a roller bearing in the first taper of the first wall section. Installing the locking assembly also includes providing a first wedge including a first surface and a second surface opposite the first surface and including a taper extending into the first wedge from the second surface toward the first surface. Additionally, installing the locking assembly includes installing the first wedge within the groove of the first wall section with a first spring such that the first taper of the first wall section and the taper of the second surface of the first wedge are adjacent to each other and form a first taper pocket in which the first bearing assembly is positioned; the first spring biases the first wedge to engage the lever; and the lever is able to switch the linear clutch between an unlocked state in which the linear clutch is able to move along the object in the first direction and the second direction and a locked state in which the linear clutch cannot move along the object in the first direction.

According to yet another embodiment of the present invention, a locking assembly for a linear clutch includes a first wedge having a first surface and a second surface opposite the first surface, with the second surface including a taper extending into the first wedge from the second surface toward the first surface. The locking assembly also includes a first spring configured to bias the first wedge and a first bearing assembly configured to fit within the taper of the first wedge and including a first roller bearing. Furthermore, the locking assembly includes a lever configured to engage the wedge and to move between an unlocked position and a locked position.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description but is only limited by the scope of the appended claims.

What is claimed is:

1. A linear clutch comprising:
a main body;
a support panel section comprising an outer side and an inner side opposite the outer side;
a first wall section extending from the inner side of the support panel section, the first wall section comprising:
a groove adjacent to the inner side of the support panel section; and
a first taper adjacent to and extending away from the groove;
a second wall section extending from the inner side of the support panel section and spaced apart from the first wall section; and
a channel extending through the main body adjacent to the groove of the first wall section and defined by the second wall section and the inner side of the support panel section, the channel configured to receive an object therethrough such that the linear clutch is movable along the object in a first direction and a second direction; and
a locking assembly configured to engage the groove and the taper of the first wall section, the locking assembly comprising:
a first wedge positioned within the groove of the first wall section, the first wedge comprising:
a first surface adjacent to the channel; and
a second surface opposite the first surface, the second surface comprising a taper extending into the first wedge from the second surface toward the first surface and positioned adjacent to the first taper of the first wall section to form a first taper pocket;
a first bearing assembly positioned within the first taper pocket and comprising a first roller bearing;
a lever secured at the first wall section and engaged with the wedge, the lever configured to switch the linear clutch between an unlocked state in which the linear clutch is able to move along the object in the first direction and the second direction and a locked state in which the linear clutch cannot move along the object in the first direction; and
a first spring biasing the first wedge to engage the lever.

2. The linear clutch of claim 1 wherein the outer side of the support panel section comprises a mounting flange configured to mount a second object to the linear clutch.

3. The linear clutch of claim 2 wherein the outer side of the support panel section comprises a groove adjacent to the mounting flange and configured to receive the second object therein.

4. The linear clutch of claim 1 wherein the second wall section comprises a projection extending into the channel and configured to fit within a groove on the object.

5. The linear clutch of claim 1 wherein the lever is configured to engage the first wedge via a roller drive coupled to the first wedge.

6. The linear clutch of claim 5 wherein the lever is configured to engage the roller drive via a cam coupled to the lever.

7. The linear clutch of claim 1 wherein:
when the linear clutch is in the unlocked state, the first taper pocket has a size and shape that allows the first roller bearing of the first bearing assembly to rotate freely within the first taper pocket when the linear clutch moves along the object in the first and second directions; and
when the linear clutch is in the locked state, the first taper pocket has a shape that allows the first roller bearing of the first bearing assembly to rotate freely within the first taper pocket when the linear clutch moves along the object in the second direction and prevents the first roller bearing of the first bearing assembly from rotating freely within the first taper pocket when the linear clutch moves along the object in the first direction.

8. The linear clutch of claim 1 wherein:
the first wall section further comprises a second taper adjacent to and extending away from the groove;
the locking assembly further comprises:
a second wedge positioned within the groove of the first wall section opposite the first wedge, the second wedge comprising:
a first surface adjacent to the channel; and
a second surface opposite the first surface, the second surface comprising a taper extending into the second wedge from the second surface toward the first surface and positioned adjacent to the second taper of the first wall section to form a second taper pocket;
a second roller bearing assembly positioned within the second taper pocket and comprising a first roller bearing; and
a second spring biasing the second wedge toward the lever; and
the lever is configured to engage the second wedge when switching the linear clutch between the unlocked state and the locked state such that, when the linear clutch is in the locked state, the linear clutch cannot move along the object in the second direction.

9. The linear clutch of claim 1 wherein:
the locking assembly further comprises a second spring biasing the first wedge to engage the lever; and
each of the first and second springs comprises a spring.

10. The linear clutch of claim 1 wherein the first bearing assembly further comprises:
a second roller bearing; and
a roller cage retaining the first and second roller bearings.

11. The linear clutch of claim 1 wherein the support panel, first wall, and second wall sections of the main body are formed as an integral unit.

12. A method of manufacturing a linear clutch, the method comprising:
providing a main body comprising:
a support panel section comprising an outer side and an inner side opposite the outer side;
a first wall section extending from the inner side of the support panel section, the first wall section comprising:
a groove adjacent to the inner side of the support panel section; and
a first taper adjacent to and extending away from the groove;
a second wall section extending from the inner side of the support panel section and spaced apart from the first wall section; and
a channel extending through the main body adjacent to the groove of the first wall section and defined by the second wall section and the inner side of the support panel, the channel configured to receive an object therethrough such that the linear clutch is movable along the object in a first direction and a second direction; and
installing a locking assembly onto the main body by:
securing a lever at the first wall section;
installing a first bearing assembly comprising a roller bearing in the first taper of the first wall section;
providing a first wedge comprising:
a first surface; and
a second surface opposite the first surface and comprising a taper extending into the first wedge from the second surface toward the first surface;
installing the first wedge within the groove of the first wall section with a first spring such that:
the first taper of the first wall section and the taper of the second surface of the first wedge are adjacent to each other and form a first taper pocket in which the first bearing assembly is positioned;
the first spring biases the first wedge to engage the lever; and
the lever is able to switch the linear clutch between an unlocked state in which the linear clutch is able to move along the object in the first direction and the second direction and a locked state in which the linear clutch cannot move along the object in the first direction.

13. The method of claim 12 wherein the first wall section comprises a second taper adjacent to and extending away from the groove; and
wherein installing the locking assembly onto the main body further comprises:
installing a second bearing assembly comprising a roller bearing in the second taper of the first wall section;
providing a second wedge comprising:
a first surface; and
a second surface opposite the first surface and comprising a taper extending into the second wedge from the second surface toward the first surface;
installing the second wedge within the groove of the first wall section with a second spring such that:
the second taper of the first wall section and the taper of the second surface of the second wedge are adjacent to each other and form a second taper pocket in which the second bearing assembly is positioned;
the second spring biases the second wedge to engage the lever; and
when the lever switches the linear clutch into the locked state, the linear clutch cannot move along the object in the second direction.

14. The method of claim 12 wherein installing the locking assembly onto the main body further comprises coupling a roller drive to the first wedge such that the wedges engages the lever via the roller drive.

15. The method of claim 14 wherein installing the locking assembly onto the main body further comprises coupling a cam to the lever such that the wedge engages the lever via the roller drive and the cam.

16. A locking assembly for a linear clutch, the locking assembly comprising:
a first wedge comprising:
a first surface; and
a second surface opposite the first surface, the second surface comprising a taper extending into the first wedge from the second surface toward the first surface;
a first spring configured to bias the first wedge;
a first bearing assembly configured to fit within the taper of the first wedge and comprising a first roller bearing; and
a lever configured to engage the wedge and to move between an unlocked position and a locked position.

17. The locking assembly of claim 16 further comprising:
a second spring;
a second wedge configured to engage the second spring and the lever, the second wedge comprising:
a first surface; and
a second surface opposite the first surface, the second surface comprising a taper extending into the first wedge from the second surface toward the first surface; and
a second bearing assembly configured to fit within the taper of the second wedge and comprising a first roller bearing.

18. The locking assembly of claim 16 wherein the first wedge further comprises an opening therein configured to receive the first spring.

19. The locking assembly of claim 16 wherein the first wedge further comprises:
a notch configured to receive a roller drive therein; and
an opening configured to receive a pin coupling the roller drive to the first wedge.

20. The locking assembly of claim 19 further comprising a cam configured to couple to the lever and to engage the roller drive.
